(19) United States
(12) Patent Application Publication
(10) Pub. No.: US 2012/0072249 A1
(43) Pub. Date: Mar. 22, 2012

(54) SYSTEM AND METHOD FOR SENDING TRAVEL INFORMATION TO A WIRELESS MOBILE DEVICE

(75) Inventors: Marshall G.A. Weir, Cambridge, MA (US); Benjamin H. Kazez, Ann Arbor, MI (US)

(73) Assignee: Mobiata LLC, Ann Arbor, MI (US)

(21) Appl. No.: 12/888,265

(22) Filed: Sep. 22, 2010

(51) Int. Cl. G06Q 10/00

(52) U.S. Cl. 705/5

(57) ABSTRACT

A system registers mobile devices for flight status updates and sends relevant updates to the wireless devices. Flight status updates are processed by the system and evaluated for their usefulness to the end-user. Updates that are above a minimum level of usefulness are sent to the mobile device. The system compensates for missing and/or invalid data in flight status updates. In addition to flight status updates, the system may evaluate and provide status updates for complete travel itineraries including, but not limited to, connecting flights, hotel availability and transportation options.

### BACKGROUND OF THE INVENTION

1. Field of the Invention

The present invention is directed generally to communications with a wireless mobile device and, more particularly, to a system and method for sending travel information to a wireless mobile device.

2. Description of the Related Art

Flight data aggregation companies have developed technology that enables applications to query for flight information updates as needed. In recent years, some companies have added a “push” mode to the more common “pull” mode that responds to user queries. In the push mode, an application can register for flight change requests and receive notifications as flight information changes. However, such systems are limited in their usefulness to the end-user due to the sheer number of flight updates that can occur. Each data item associated with a flight can change at any time, including (for both departure and arrival) scheduled runway time, estimated runway time, actual runway time, scheduled gate time, estimated gate time, actual gate time, gate, terminal, and so on. Moreover, data items such as the times described above can change frequently, and can even oscillate among multiple values if the flight data aggregator receives conflicting data from multiple sources. For a traveler trying to act on flight information updates, such an overwhelming influx of data renders virtually all received data useless. Therefore, it can be appreciated that there is a significant need for a system and method that limits flight notifications to those that are actually applicable to a given user. The present invention provides this, and other advantages as will be apparent from the following detailed description and accompanying figures.

### BRIEF DESCRIPTION OF THE SEVERAL VIEWS OF THE DRAWING(S)

FIG. 1 illustrates a sample system architecture used to implement the system of the present disclosure.

FIG. 2 is a functional block diagram of the flight update server illustrated in FIG. 1.

FIG. 3 illustrates a mobile device registration process with the flight update server of FIG. 2.

FIG. 4 illustrates a process for handling event data by the flight update server of FIG. 2.

FIG. 5 is a flow chart illustrating the operation of the system of FIG. 1 to measure relevance or usefulness of change data to the end-user.

### DETAILED DESCRIPTION OF THE INVENTION

As discussed above, flight data aggregation sources often provide overwhelming amounts of data that may be irrelevant to the end-user. For any given flight there are often 15-30 status updates, of which five may contain useful information for the end-user. The techniques described below register a wireless mobile device and track an itinerary. Furthermore, the large amounts of data are analyzed to determine which pieces of information are relevant or useful to the end-user. Only that relevant or useful data is sent to the end-user. As described below, other travel data sources permit the technology described herein to be applied to other modes of travel.

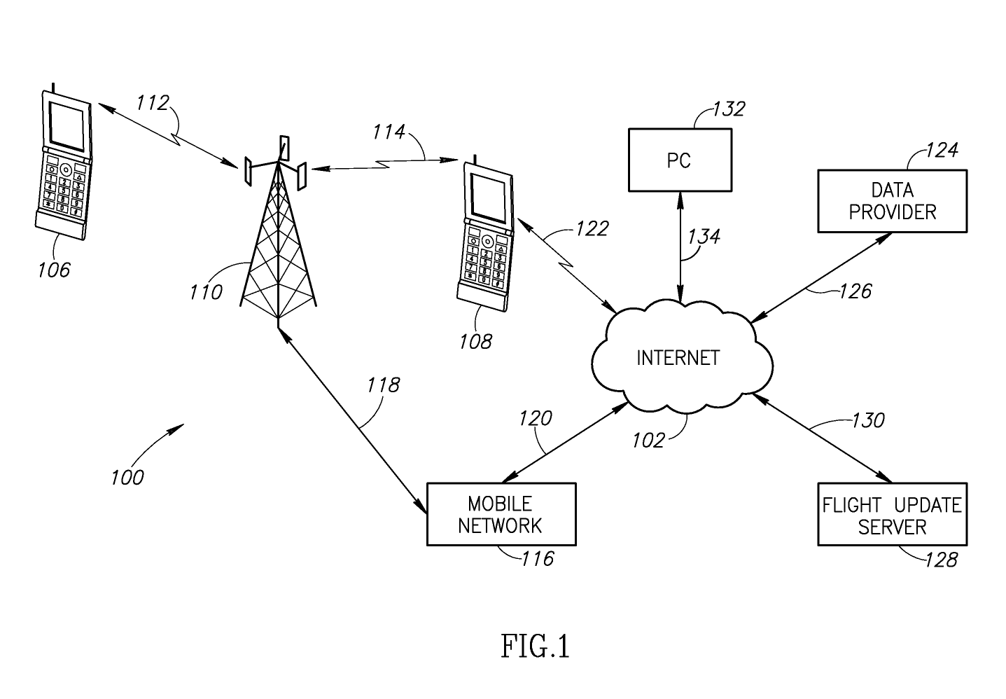

The invention is embodied in a system 100 illustrated in the system architecture of FIG. 1. The system 100 takes advantage of a conventional wide-area network, such as the Internet 102, to provide communication links with various components.

FIG. 1 illustrates wireless devices 106-108, which are operated by end-users. The wireless devices 106-108 communicate with a base station 110 via communication links 112-114, respectively. The system 100 may be satisfactorily implemented on virtually any wireless communication system. That is, the system 100 may be implemented on a 2G network utilizing only SMS communication. Alternatively, the system 100 may be implemented with a 3G or 4G wireless network. Furthermore, the system 100 may be implemented in accordance with one or more communication standards. That is, the system 100 may be implemented using a GSM, CDMA, TDMA, FDMA, OFDMA, W-CDMA, CDMA2000, LTE, or other communication standard. With the present disclosure, one of ordinary skill in the art can implement the system 100 on various types of communication networks. Although FIG. 1 illustrates only a single base station 110, those skilled in the art will appreciate that typical wireless network comprises a large number of base stations distributed throughout a geographic region of coverage. However, for the sake of simplicity, FIG. 1 illustrates only the base station 110.

The base station 110 is coupled a mobile network 116 by a communication link 118. While the communication links 112-114 are wireless communication links, the communication link 118 between the base station 110 and the mobile network 116 may be implemented using a variety of known techniques, such as a hard wired connection, fiber optic, wireless (e.g., a microwave link), or the like. The communication link 118 may also be implemented by one or more of these conventional technologies in combination.

As is known in the art, the mobile network 116 typically provides voice communications for the wireless devices 106-108. In addition, the mobile network 116 may serve as an access point to the Internet 102. In FIG. 1, the mobile network 116 is coupled to the Internet via a communication link 120. The communication link 120 may be implemented by a variety of technologies, such as those described above with respect to the communication link 118.

As will be described in greater detail below, the wireless devices 106-108 communicate with the Internet 102 via the mobile network 116. In addition, the wireless device 108 may communicate directly with the Internet 102 via a wireless communication link 122. As is known by those skilled in the art, modern wireless devices (e.g., the wireless device 108) may be referred to as “smart phones” that have Internet access via the mobile network 116 using the conventional wireless network circuitry. However, many smart phone devices also include additional communication capability, such as Bluetooth or WiFi (i.e., IEEE 802.11) that permits communications between the Internet and the wireless communication device 108 via a “hot-spot” or other well known wireless access point (WAP). The system 100 may be implemented with wireless devices (e.g., the wireless device 108) that has multiple modes of communication.

A data provider 124 is also coupled to the Internet 102 via a communication link 126. The data provider 124 is intended to represent one or more servers on which flight data aggregation companies provide the flight data described herein.

FIG. 1 also illustrates a flight update server 128 coupled to the Internet 102 via a communication link 130. As will be described in greater detail below, the flight update server 128 receives flight data from the data provider 124 and analyzes it to determine its relevancy to the scheduled itinerary of a registered end-user.

Those skilled in the art will appreciate that communication between various elements (e.g., the data provider 124 and the flight update server 128) of FIG. 1 occurs via the Internet 102. Although illustrated in FIG. 1 as simple communication links (e.g., the communication links 126 and 130), a typical connection may include firewalls, routers, switches, and the like. For the sake of simplicity, those conventional elements are not illustrated in FIG. 1.

FIG. 1 also illustrates a computing device, such as a personal computer (PC) 132, which is coupled to the Internet 102 via the communication link 134. The PC 132 may be any known form of computing device, such as a desktop computer, laptop computer, or the like. The communication link 134 may be a wired connection, such as a dial-up modem, DSL connection, cable modem, wireless connection, or the like.

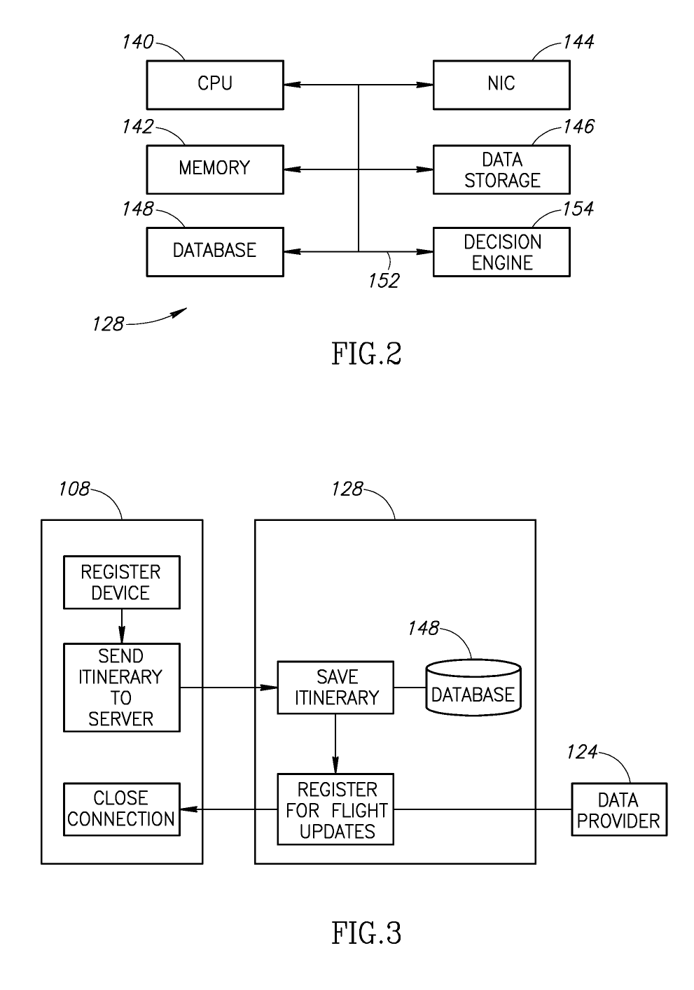

FIG. 2 illustrates a functional block diagram of the flight update server 128. The flight update server 128 includes a number of conventional components whose operation is well understood. The flight update server 128 includes a central processing unit (CPU) 140 and a memory 142. In general, the memory 142 contains data and instructions that are executed by the CPU 140. The CPU 140 may be implemented as a conventional microprocessor, microcontroller, programmable gate array, application specific integrated circuit, or the like. The system 100 is not limited by the specific implementation of the CPU 140. Similarly, the memory 142 may be implemented by a variety of known technologies. The memory 142 may include dynamic memory, static memory, programmable memory, or the like. A portion of the memory 142 may be integrated into a single chip with the CPU 140. The system 100 is not limited by any specific implementation of the memory 142.

FIG. 2 also includes a network interface controller (NIC) 144. The NIC 144 is representative of many types of network communication devices, such as an Ethernet connection, fiber optic connection, wireless interface, or the like. The various interfaces represented by the NIC 144 are well known in the art and need not be described in greater detail herein. The NIC 144 permits communication between the flight update server 128 and the Internet 102.

FIG. 2 also illustrates a data storage element 146, such as a magnetic drive, optical drive, tape drive, or the like. A database 148 or other data storage structure is included in the flight update server 128 to store end-user registration information and flight itinerary information. The operation of the database 148 will be described in greater detail below. The database 148 may be implemented as a portion of the memory 142 or a portion of the data storage 146. In these embodiments, the database 148 may be co-located with the flight update server 128. Alternatively the database 148 may be remote from the flight update server 128 and coupled to the flight update server by a local area network (not shown) or a wide area network, such as the Internet 102. Although elements of the flight update server 128 may be implemented as a distributed computing system, its functionality as described herein can be readily understood by those of ordinary skill in the art.

The flight update server 128 also includes a decision engine 150. As will be described in detail below, the decision engine 150 receives the end-user itinerary and the aggregated flight data. The decision engine 150 analyzes the data to determine its relevance or usefulness to the end-user itinerary and ultimately makes the decision whether or not to pass any updated information along to the wireless device (e.g., the wireless device 108).

The various components in the block diagram of FIG. 2 are coupled together by a bus system 152. The bus system 152 may include a data bus, address bus, control bus, power bus, and the like. For the sake of simplicity, those various buses are illustrated in FIG. 2 as the bus system 152.

Some components illustrated in the functional block diagram of FIG. 2 may be implemented as computer instructions stored in the memory 142 and executed by the CPU 140. For example, the database 148 and the decision engine 150 may be readily implemented as a set of instructions stored in the memory 142. However, these components are illustrated as separate elements in the functional block diagram of FIG. 2 because each performs a separate function.

At the outset an end-user must register the wireless device (e.g., the wireless device 108) with the flight update server 128. That process is illustrated in FIG. 3. The necessary instructions for registration and display of flight information on the wireless devices 106-108 may be readily implemented using an application program executing on the respective wireless devices. In one embodiment, the necessary travel update application program may be pre-loaded on the wireless device as supplied by the device manufacturer and/or service provider. Alternatively, it is well known to download application programs to the wireless devices 106-108. In this embodiment, the application program may be downloaded from the mobile network 116 via the base station 110. Alternatively, the application program may be downloaded to the wireless device (e.g., the wireless device 108) directly from the Internet 102 using, by way of example, the WiFi wireless communication link 122 (see FIG. 1).

As illustrated in the flowchart of FIG. 3, the mobile device 108 performs a registration operation to register the wireless device with the flight update server 128. The device registration includes contact information, such as the telephone number of the wireless device or the e-mail address associated with the wireless device. The end-user may also specify communication preferences, such as telephone, e-mail, text messaging, or the like. The system 100 may also provide for different types of notification for different times. For example, changes to the itinerary that occur more than 24 or 48 hours prior to the trip may be sent, by way of example, using email. The email may be retrieved by the user's personal computer or via the wireless communication device (e.g., the wireless communication device 108 in FIG. 1). Conversely, the system 100 may use text messaging to the wireless communication device 108 for itinerary changes that occur less than 1-2 hours prior to departure. Finally, the system 100 may use voice messaging for changes to the itinerary that occur closer to departure time. The time periods described above are merely examples to illustrate the possible modes of communication and how the different modes of communication may change as departure time approaches. The system 100 is not limited by the specific communication modality or the example time periods discussed above. In one embodiment, the system 100 may select default time periods for the various communication modes. Alternatively, the system 100 may permit user selection of time periods associated with different modes of communication. The device identification, contact preferences, and itinerary are saved by the flight update server 128 for future use. In addition, the mobile device 108 sends the end-user itinerary to the flight update server 128. The flight information includes the flight number, airline, departure airport and time, arrival airport and time, and the like. Itinerary information may also include data related to connecting flights, car rental or transportation information, hotel reservations, and the like.

The identification information and contact information may be entered manually by the user a single time and stored in the wireless device 108 in association with the travel update application program. Upon subsequent execution of the application program, the stored identification and contact information may be automatically forwarded to the flight update server 128. Alternatively, the identification and contact information may be stored indefinitely in the flight update server 128. In addition, the itinerary data may be manually entered into the wireless device 108 by the end-user or automatically entered by a service provider that provides itinerary data to the wireless device. This data could be provided by the travel provider, such as the airline, train line, cruise ship line, travel agency, or the like. Alternatively, the flight update server 128 may retrieve specific itinerary data from the travel provider. For example, the user could partially identify the itinerary, such as day and airline, and the flight update server 128 can retrieve the detailed information. Following the registration, the wireless device 108 may close the connection with the flight update server 128.

After receiving the information from the wireless device 108, the flight update server 128 stores the identification information, contact preference information, and itinerary data in the data storage 146 and/or the database 148. In an exemplary embodiment, the flight data is stored until the arrival time of the flight is twenty-four hours old. At that time, the flight data may be automatically deleted. At the user's preference, identification information and contact preference information may be stored indefinitely in the database 148 for future use. The flight update server 128 may also store time zone information for each wireless device as well as a list of flights and other travel information associated with each wireless device.

In one embodiment, the system 100 can permit flight registration via a wireless communication device, as described above, or permit the initial registration via the PC 132 (see FIG. 1). When using the PC 132 to perform the Initial registration, the user can include contact information, such as the telephone number for the wireless communication device (e.g., the wireless communication device 108), as well as an email address and other contact information, as discussed above.

Once all of the necessary data is received by the flight update server 128, the flight update server communicates with the data provider 124 to arrange for status updates. As previously discussed, the data provider 124 may operate in a push mode where data is provided only upon inquiry. In this embodiment, the flight update server 128 periodically sends a query to the data provider 124 to extract the requested data. Alternatively, if the data provider 124 operates in a push mode, the flight update server 128 can simply register with the data provider to request updated information on selected flights. In this embodiment, the data provider 124 automatically provides updated information for any flights registered with it by the flight update server 128.

As noted above, the data provider 124 represents one or more servers that provide travel information. While the example presented herein focuses on airline travel, those skilled in the art will appreciate that the principles of the system 100 can be readily applied to any common carrier in which scheduling information may be accessed by the system 100. For example, flight information may be available from the Federal Aviation Administration (FAA) or from a number of commercial services that track airline flights and provide information. In addition, organizations such as the International Civil Aviation Organization (ICAO) have developed a tracking system known as an automated dependent surveillance-broadcast (ADS-B) system. With an ADS-B system, satellites provide commercial aircraft with precise location information. The aircraft, in turn, relay that information through other radio channels. The data available from ADS-B can provide precise tracking information as another implementation of the data provider 124. With respect to other forms of transportation, trains, subways, municipal busses, and ferries also provide information that may be publically available and may thus be considered forms of the data provider 124. For example, the Washington State Ferry System includes GPS tracking on all ferries and makes this information available through a website. In addition, the ferry system generates automatic messages to inform users of scheduling delays. The system 100 may extract these forms of information to provide updated ferry travel itineraries. Similarly, passenger trains are often equipped with similar tracking technology that can be accessed through the Internet 102. Thus, passenger train information may also be a form of the data provider 124 to provide up-to-the-minute train travel information. The flight update server 128 provides examples of updates for airline travel. However, the update server 128 may be readily applicable to other modes of travel. The various sources of travel information, such as airline, ferry, train and the like, may be generically referred to herein as “travel data sources.” Thus, the system 100 is not limited to airline travel.

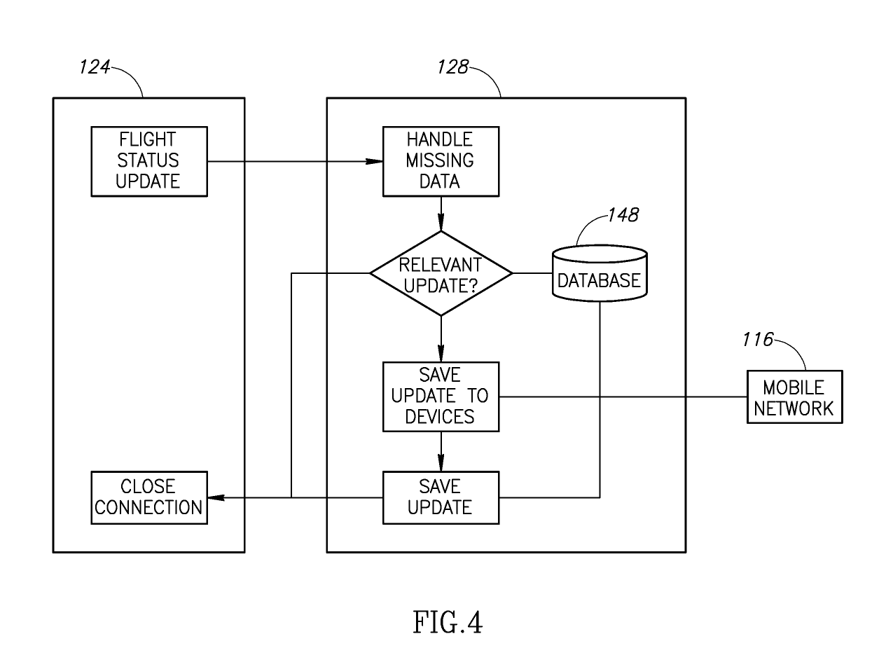

FIG. 4 illustrates the event handling process used by the flight update server 128 when it receives information from the data provider 124. The data provider 124 sends a flight status update to the flight update server 128 via the Internet 102. For event processing, the flight update server 128 must first handle missing data and then compare the event to the last set of data in the flight update server 128 to determine if it is useful to the end-user. The first step of processing an update is to handle the missing data. There are a large number of different times provided for each flight arrival and departure. For example, the system 100 can provide airline departure updates, using the first time entry found in the following list to compare to previous events:

1. Actual gate departure;

2. Actual runway departure;

3. Estimated gate departure;

4. Scheduled gate departure;

5. Estimated runway departure;

6. Scheduled runway departure; and

7. Published departure.

The term “event” is defined herein as a set of data received from the data provider 124 with data for one or more flights. If the data provider 124 is responding to a query from the flight update server 128, there may not be any changes from the previous query. However, if the data provider 124 is employed in a push implementation, each event received from the data provider would indicate that some changes have been made in the flight information. The flight update server 128 compares the newly received event from the data provider 124 with the previous event, which may be stored in the data storage 146 (see FIG. 2) of the flight update server. Because many elements of the data may not be available to the data provider 124, an event is often provided with missing data.

The flight update server evaluates the received event to extract useful data and compensate for missing data. When comparing two events, the flight update server 128 finds the first available time in the list provided above to use for comparison to the prior stored event. Thus, in one example, the actual runway departure time from one event may be compared to the estimated gate departure time from a different event. The flight update server 128 can calculate delay times even though certain information may be missing from an event. In the example described above, the actual gate departure in a current event can be compared with the scheduled gate departure or estimated gate departure from a prior event to determine flight delay information. Thus, the flight update server 128 can accommodate missing information from an event.

Flight status, gate changes and terminal changes can be ignored by the flight update server 128 if the data is missing. If a new event includes one or more of these data elements and the previous event did not, the new data can be marked as useful to the user.

The arrival information uses a list similar to that illustrated above, but checks for the available arrival times, such as actual gate arrival, actual runway arrival, estimated gate arrival, and the like. The flight update server 128 handles missing data for flight arrivals in a manner such as that described above for departure information.

Once the missing data is handled, the received update is compared with the last useful data for that flight. This is either the original published schedule data for the flight or the data from the last useful update. The updated data may be temporarily stored in the database. The flight update server 128 also determines the relevance of updated information. In one embodiment, the determination of what is relevant can be made based on information about the end user, by way of example, whether he/she is the traveler or is making an airport pickup. Any relevant updated information is forwarded to the wireless device 108. The updated information may be sent to the wireless device 108 via the mobile network 116 or via the WiFi wireless connection 122 (see FIG. 1). The flight update server 128 saves updated information and closes the connection with the data provider 124.

The flight update server 128 may also save a copy of the information sent to the end-user and designate this information as the “last event.” When a new event is received from the data provider 124, the flight update server 128 may determine changes, as described above, and compare those changes to the last event sent to the user. Based on this comparison, the flight update server may determine whether or not to send additional flight change information to the end-user. For example, the data provider 124 often sends multiple events within a short period of time with minor changes from the prior event. In addition, other data sources, such as the FAA, send multiple messages with minor changes. For example, a flight may have been delayed 15 minutes as indicated by a previous event. This notification may have been sent to the user and is saved as the last event. One or more new events from the data provider 124 may indicate a change in the delay from 15 minutes to 17 minutes. However, this is a relatively minor change. Thus, the flight update server 128 will compare the 17 minute delay notification from the current event with the last event that informed the end-user of a 15 minute delay. Based on this minor additional delay, the flight update server 128 will ignore the new event indicating the additional 2 minute delay.

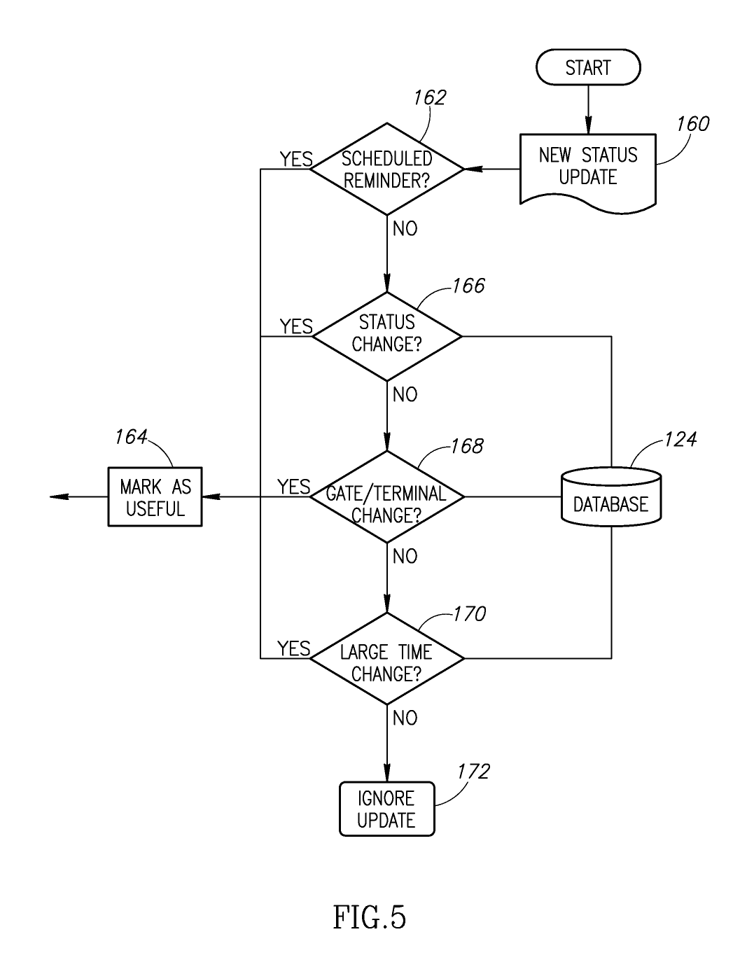

FIG. 5 illustrates the processing by the decision engine 150 (see FIG. 2) to determine the relevance of new data. As previously discussed, the system 100 analyzes received update information to determine its relevance or usefulness to the end-user and only transmits updated data that has been determined to be relevant or useful to the end-user.

FIG. 5 illustrates the processing by the decision engine 150 to determine the relevance of new information. At step 160 a new status update is received from the data provider 124. In decision 162, the decision engine determines whether the update is a scheduled reminder. The end-user may optionally request a scheduled reminder to be sent at a predetermined time prior to the start of travel. In the example of airline travel, the scheduled reminder could be sent, by way of example, 2 hours prior to departure. If delays occur, the flight update server 128 can automatically reschedule the reminders based on the actual expected departure time. If the update is a scheduled reminder, the result of decision 162 is YES and, in that case, the update is marked as useful. In step 164 if the new status update is not a scheduled reminder, the result of decision 162 is NO and, in step 166, the decision engine 150 determines whether the status update is a status change. There is a long list of status changes that may be sent to the flight update server 128 by the data provider 124. Some status changes are useful only to airport personnel. For example, notifications about arrival time changes for a flight that is already marked “landed” may be useful for improving airport operations, but not for traveling. For the system 100, if the status in an event from the data provider 124 is a departed status, landed status, canceled status, redirected status, or diverted status, the flight update server 128 will send a notification to the end-user. In step 166, the decision engine 150 determines whether the status of the flight has changed from the previous data. If the status update is indicative of a status change, the result of decision 166 is YES and, in step 164, the decision engine marks the status update as useful. If the status update is not indicative of a status change, the result of decision 166 is NO and, the decision engine moves to decision 168.

In decision 168, the decision engine 150 determines whether the status update is indicative of a gate or terminal change. If so, the result of decision 168 is YES and, in step 164, the decision engine 150 marks the status change as useful. If the status update is not indicative of a gate or terminal change, the result of decision 168 is NO and, in step 170, the decision engine determines whether the status update is indicative of a large time change. In one embodiment, the time change may be considered a large time change if it is at least ten minutes different from the previous event. That is, either the arrival time or the departure time is at least ten minutes different from the previous event. In an alternative embodiment, the decision engine 150 may evaluate the overall itinerary to determine whether the time change is significant. For example, a ten minute time change may be significant if the end-user has a layover of, for example, one hour. However, if the end-user has a layover of four hours, by way of example, a ten-minute change in arrival time or departure time may not be considered relevant to the overall itinerary. If the time change is considered a large time change, the result of decision 170 is YES and, in step 164, the decision engine 150 marks the status update as useful. If the time change is not considered a large time change, the result of decision 170 is NO and, in step 172, the decision engine ends the analysis by ignoring the updated status information.

Also illustrated in FIG. 5, status change, gate/terminal change and time change information resulting from the analysis of decisions 168-170 are also stored in the database 124 or the data storage 146 (see FIG. 2). As previously discussed, this change information considered useful will be sent to the end-user and stored in the data structure 146 or the database 124 as the last event.

Those skilled in the art will appreciate the change thresholds may be important as there are many updates to flight data that are provided by travel data sources that change the time by only a few minutes and that are not useful to the end-user. In addition, changes may happen rapidly. There are occasions where time updates are changed five or more times within one minute.

If the update is marked as useful (step 164) by the decision engine 150, the flight update server 128 will notify all users registered for that flight and send a message to each of them with the updated data. In addition, the current update is saved to the database 124 as the last event for comparison with the next update received by the flight update server 128. As previously noted, updates may be sent to the wireless devices 106-108 using the contact information and preferences provided by the user during the registration process. The updates may be provided to the wireless devices 106-108 via the mobile network 116 (see FIG. 1) or directly from the Internet 102 via the WiFi wireless connection 122.

The foregoing description utilizes examples from the perspective of the traveler. However, those skilled in the art will appreciate that the system 100 may be readily utilized by a third party to track an itinerary. For example, the third party may be meeting the traveler at the airport and will find the system 100 useful in tracking changes in the traveler's itinerary such as arrival times and/or arrival terminal or gate. As described above, the third party can utilize a wireless device (e.g., the wireless communication device 108 of FIG. 1), the PC 132 to initiate a registration with the flight update server 128. The system 100 operates in the same manner described above and provides the same type of notifications as specified by user preference data provided during the registration. Thus, the system 100 has great utility for the traveler and any third party having a need to monitor the traveler's itinerary.

In addition, the examples presented herein relate to flight travel. However, those skilled in the art will appreciate that the system 100 can be satisfactorily employed for other forms of travel, such as trains, busses, taxis, automobile rentals, and the like. For example, an auto rental agency can utilize the system to track the itinerary of a traveler and will know when the traveler will arrive at, by way of example, the airport. Similarly, a taxi company may utilize the system 100 to track the itinerary of a traveler to meet the traveler at an appointed location, such as an airport, train station or the like. In addition, the system 100 can be employed to track other travel reservations, such as hotel reservations. In this manner, a hotel could track a traveler itinerary and know when to expect the arrival of the guest traveler. Thus, the system 100 is broadly applicable to various forms of travel.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A system comprising:
a wireless device having a transceiver and configured for communication via a communication network and to provide a user travel itinerary via the communication network;
a data provider server configured to provide travel information related to the travel itinerary via the communication network; and
a travel update server configured to receive the travel information from the data provider server, the travel update server further configured to compare the user travel itinerary with the received travel information to determine changes in the user travel itinerary based on the received travel information, the travel update server determining if any changes in the user travel itinerary are relevant, and sending a notification to the wireless device only if the changes are relevant to the user itinerary.

2. The system of claim 1 wherein the travel update server further comprises a decision engine to determine if any changes in the user travel itinerary are relevant to the user itinerary.

3. The system of claim 2 wherein the decision engine determines relevancy to the user itinerary based on changes in travel times that exceed a predetermined threshold.

4. The system of claim 2 wherein the travel plans comprise airline travel and the decision engine determines relevancy to the user itinerary based on one or more changes for the airline travel selected from a list of changes comprising gate changes, terminal changes, and baggage claim changes.

5. The system of claim 1 wherein the data provider server is configured to provide flight information related to the user travel itinerary.

6. The system of claim 1 wherein the communication network comprises a base station associated with a wireless communication network and the transceiver is configured to communicate with the communication network via the base station.

7. The system of claim 1 wherein the communication network comprises a wireless access point communicatively coupled to a wide area network and the transceiver is configured to communicate with the communication network via the wireless access point.

8. The system of claim 1 wherein the wireless communication device is further configured to provide registration information to the travel update server.

9. The system of claim 8 wherein the registration information comprises contact information for a user of the wireless communication device.

10. The system of claim 9 wherein the registration information comprises contact preference information for a user of the wireless communication device selected from a group of preferences comprising telephone contact preference, text-message preference, and email preference.

11. The system of claim 1 wherein the travel update server is further configured to generate an inquiry to the data provider server wherein the travel information received from the data provider server is received in response to the inquiry.

12. The system of claim 1 wherein the travel update server is configured to generate an inquiry to the data provider server for a plurality of travel segments.

13. The system of claim 1 wherein the travel update server is configured to generate an inquiry to the data provider server for each of a plurality of travel segments.

14. The system of claim 1 wherein the travel update server is further configured to provide travel data registration information to the data provider server and to automatically receive the travel information from the data provider server in response to the travel data registration information.

15. A system comprising:
a network interface configured to receive itinerary information related to a user itinerary from a first data source and travel information from a second data source;
a data storage structure configured to store the itinerary information received from the first data source in association with user identification information;
a processor configured to communicate with a second data source via the network interface, the processor receiving travel information from the second data source, the travel information being related to the user itinerary, the processor being further configured to evaluate the travel information received from the second data source with respect to the user itinerary received from the first data source and to determine the relevance of the travel information received from the second data source to the user itinerary received from the first data source and to communicate changes to the user itinerary if determined to be relevant to the user itinerary.

16. The system of claim 15 wherein the processor determines relevancy to the user itinerary based on changes in travel times that exceed a predetermined threshold.

17. The system of claim 15 wherein the user itinerary comprises airline travel and the processor determines relevancy to the user itinerary based on gate changes for the airline travel.

18. The system of claim 15 wherein the first data source is a wireless communication device configured for communication with a wireless network and the network interface is configured to communicate with the wireless communication device via the wireless network.

19. The system of claim 15 wherein the first data source is a wireless communication device configured for communication with a wide area network and the network interface is configured to communicate with the wireless communication device via the wide area network.

20. The system of claim 15 wherein the first data source is a personal computer configured for communication with a wide area network and the network interface is configured to communicate with the personal computer via the wide area network.

21. The system of claim 15 wherein the first data source is a third party computing device and the network interface is configured to communicate with the third party computing device to receive the itinerary information and the user identification information from the third party computing device.

22. The system of claim 15 wherein the network interface is further configured to receive contact information from the first data source, and the processor is further configured to use the contact information to communicate relevant changes to the user itinerary.

23. The system of claim 22 wherein the contact information comprises contact preference information selected from a group of preferences comprising a telephone contact preference, a text-message preference, and an email preference.

24. The system of claim 15 wherein the processor is further configured to generate an inquiry to the second data source wherein the travel information received from the second data source is received in response to the inquiry.

25. The system of claim 15 wherein the processor is further configured to provide travel data registration information to the second data source and to automatically receive the travel information from the second data source in response to the travel data registration information.

26. A method for providing updated travel information comprising:
providing a user travel itinerary and user registration information to a travel update server;
storing the user travel itinerary and user registration information in a data storage structure associated with the travel update server;
receiving travel updates from a travel data source;
analyzing the travel updates from the travel data source with respect to the stored user travel itinerary to determine if any travel updates are useful to the user travel itinerary; and
communicating the useful travel updates to the user.

27. The method of claim 26 wherein analyzing the travel updates comprises determining that travel updates are useful if the travel updates are changes in travel times that exceed a predetermined threshold.

28. The method of claim 26 wherein the user travel itinerary includes airline travel and analyzing the travel updates comprises determining that travel updates are useful if the travel updates are gate changes for the airline travel.

29. The method of claim 26 wherein providing the user travel itinerary and user registration information comprises using a wireless communication device to communicate with a wireless communication network and communicating the useful travel updates to the user comprises communicating with the user wireless communication device.

30. The method of claim 26 wherein the registration information comprises contact information for a user of a wireless communication device.

31. The method of claim 26, further comprising sending a query to the travel data source for the travel updates wherein the travel updates received from the travel data source are received in response to the inquiry.

32. The method of claim 26, further comprising registering a portion of the user travel itinerary with the travel data source for the travel updates
